(19) United States
(12) Patent Application Publication
(10) Pub. No.: US 2021/0264041 A1
(43) Pub. Date: Aug. 26, 2021

(54) METHOD AND SYSTEM FOR AUTHENTICATING THE COMPUTER-AIDED MANUFACTURING OF A THREE-DIMENSIONAL PART

(71) Applicant: VIACCESS, Courbevoie (FR)

(72) Inventor: Perez Pelage, Paris (FR)

(21) Appl. No.: 17/254,837

(22) PCT Filed: Jul. 2, 2019
(86) PCT No.: PCT/EP2019/067751

§ 371 Date: Dec. 21, 2020

(30) Foreign Application Priority Data
Jul. 3, 2018 (FR) 1856131

(51) Int. Cl. G06F 21/60; G06F 21/16; H04L 9/08; G06F 30/20; H04L 9/32

(52) U.S. Cl. CPC G06F 21/608; G06F 21/16; H04L 9/3236; G06F 30/20; H04L 9/0816

(57) ABSTRACT

Authenticating computer-aided manufacturing of a three-dimensional part by a manufacturing device, using at least one material, the part defined by a three-dimensional model obtained by computer aided design, the manufacturing device ordered for manufacturing from the model and a global set of manufacturing parameters. Method includes generating a cryptographic key as a function of the values of parameters of a subset of parameters of the global set of manufacturing parameters, including at least one parameter of a set of design parameters of the manufacturing device, or of a set of parameters relating to the manufacturing method, or of a set of characteristic parameters of the material, detecting a watermark in the model by applying a detection algorithm initialized with the cryptographic key generated, comparing the detected watermark with an expected watermark, and authenticating the manufacture of the part in the event of a positive comparison.

### CROSS-REFERENCE TO RELATED APPLICATIONS

This application claims benefit under 35 USC § 371 of PCT Application No. PCT/EP2019/067751 entitled METHOD AND SYSTEM FOR AUTHENTICATING THE COMPUTER-AIDED MANUFACTURING OF A THREE-DIMENSIONAL PART, filed on Jul. 2, 2019 by inventor Perez Pelage. PCT Application No. PCT/EP2019/067751 claims priority of French Patent Application No. 18 56131, filed on Jul. 3, 2018.

### FIELD OF THE INVENTION

The present invention relates to a method and authentication system for three-dimensional part computer-aided manufacturing.

The invention lies in the field of computer-aided manufacturing of three-dimensional models obtained by computer-aided design.

### BACKGROUND OF THE INVENTION

In the field of computer-aided manufacturing there is, on the one hand, additive manufacturing, for example 3D printing, which consists in manufacturing a part by depositing successive layers of one or more predetermined materials, and on the other hand, subtractive manufacturing, in which a 3D part is fabricated by removing material from a block of material.

In addition, computer-aided manufacturing encompasses the physical manufacturing of physical objects and so-called virtual manufacturing, which involves generating a digital twin of a physical object. The digital twin of a physical object is an object, simulated in a computer system, having the same shape and the same physical properties, and is used in phases of simulation, for example to test performance and robustness properties of the object before its actual physical manufacture, or to perform predictive maintenance of the manufactured or to be manufactured part itself, or of the manufacturing device. Virtual manufacturing is advantageous in particular in industrial prototyping phases, where it makes it possible to reduce manufacturing costs by avoiding the manufacturing of multiple expensive prototypes. It is also advantageous for the purposes of predictive maintenance, wherein it makes it possible to anticipate the occurrence of faults or failures, and therefore the need for maintenance interventions for the manufactured or to be manufactured part itself, or of the manufacturing device.

In all these cases, the computer-aided manufacturing is carried out according to a manufacturing method, on the one hand on a three-dimensional model obtained by computer-aided design and represented in a predetermined file format, and on the other hand by using a global set of manufacturing parameters which comprises a set of parameters relating to the manufacturing method, a set of parameters relating to the materials used, and a set of design parameters for the device for manufacturing the part.

In the case of additive manufacturing, and more specifically 3D printing, the manufacturing method relates to the technique used to form a layer of material. It may for example be Selective Laser Melting (SLM), in which a laser beam is directed towards a bed of powder previously deposited, or the projection of powder, or Directed Energy Deposition (DED), in which a laser beam is directed towards a jet of material to melt it as it is deposited. Other methods are known, and the invention applies to their contexts. For each of these methods, corresponding parameters have to be set.

The values of the parameters of the global set of manufacturing parameters contribute to the final properties of the manufactured object, in terms of robustness and more generally, compliance with specifications of the part to be manufactured.

The development of parameters relating to the manufacturing method and design parameters of the manufacturing device, in particular, requires the intervention of qualified operators and may, in certain applications, be long and expensive.

Particularly in the field of industrial production of three-dimensional parts using computer-aided manufacturing methods, it is important to be able to validate the authenticity of the manufacturing method of a given part.

The authenticity of the manufacturing method is referred to here as the authenticity of the association of the three-dimensional model and at least a non-empty subset of the global set of parameters.

Various methods are known for watermarking in description files of three-dimensional models or in associated digital images, with the aim of making it possible to detect possible piracy or illegitimate appropriation by a third party of a 3D model. However, such methods are only used to authenticate the 3D model used, or to ensure access by only authorized manufacturing machines to the 3D model.

One of the objectives of the invention is to improve the safety of computer-aided manufacturing of three-dimensional parts, in particular with a view to industrial manufacture of such parts.

### SUMMARY OF THE INVENTION

To this end, the invention proposes a method for authenticating the computer-aided manufacturing of a three-dimensional part by a manufacturing device, using at least one predetermined manufacturing material, said three-dimensional part to be manufactured being defined by a three-dimensional model obtained by computer aided design and shown in a predetermined file format, said manufacturing device being designed to be controlled to manufacturing said part from said three-dimensional model and an global set of manufacturing parameters. This method comprises steps of:
generation of a cryptographic key as a function of the values of the parameters of a non-empty subset of parameters of the global set of manufacturing parameters of said three-dimensional part, said non-empty subset of parameters comprising at least one parameter a set of design parameters of the manufacturing device, or at least one parameter of a set of parameters relating to the manufacturing method or at least one parameter of a set of characteristic parameters of at least one manufacturing material,
detection of a watermark in said three-dimensional model by applying a predetermined watermark detection algorithm initialized with the generated cryptographic key,
comparison of the detected watermark with an expected watermark, and authentication of the computer-aided manufacture of said three-dimensional part in the event of a positive comparison.

Advantageously, the method of the invention makes it possible to authenticate the computer-aided manufacturing of three-dimensional parts by validating in a linked manner the three-dimensional model defining the part and a non-empty subset of the global set of parameters comprising at least one parameter of a set of design parameters of the manufacturing device, and/or at least one parameter of a set of parameters relating to the manufacturing method and/or at least one parameter of a set of characteristic parameters of the at least one manufacturing material.

The three-dimensional part computer-aided manufacturing authentication method according to the invention may exhibit one or more of the characteristics below, taken independently or in any acceptable combination.

The method further comprises inhibiting a manufacturing step of said three-dimensional part in the event of a negative comparison.

The non-empty subset of parameters is determined prior to the generation of a cryptographic key and comprises said set of parameters relating to the manufacturing method, and a predetermined subset of design parameters of the manufacturing device and a predetermined subset of characteristic parameters of the at least one manufacturing material.

The generation of a cryptographic key is also dependent on a secret key.

The method further comprises extracting said set of parameters relating to the method of manufacturing metadata associated with the three-dimensional model received.

The method further comprises receiving said set of manufacturing device design parameters, a manufacturing device human-machine interface, or an external control device.

The detected watermark is formed of a series of N bits, N being a non-zero positive integer, the method comprising a step of obtaining the expected watermark from memory.

According to another aspect, the invention relates to a method of inserting a digital watermark for the authentication of computer-aided manufacturing of a three-dimensional part by a manufacturing device using at least one predetermined manufacturing material, said three-dimensional part to be manufactured being defined by a three-dimensional model obtained by computer-aided design and represented in a predetermined file format, said manufacturing device being designed to be controlled to manufacture said part from said three-dimensional model, the method comprising a step of obtaining a three-dimensional model of a three-dimensional part to be manufactured. This digital watermark insertion method comprises the steps of:
determination of a non-empty subset of a global set of manufacturing parameters of said part to be manufactured, said non-empty subset of parameters comprising at least one parameter of a subset of design parameters of the manufacturing device, or at least one parameter of a set of parameters relating to the manufacturing method or at least one parameter of a subset of characteristic parameters of the at least one manufacturing material,
generation of a cryptographic key according to the values of the parameters of said non-empty subset of parameters,
insertion according to said cryptographic key of a watermark formed of a series of N bits, N being a non-zero positive integer, by applying a predetermined watermark insertion algorithm, into said three-dimensional model to obtain a model three-dimensional watermark of said part to be manufactured.

The digital watermark insertion method for three-dimensional computer-aided manufacturing authentication according to the invention may have one or more of the features below, taken independently or in any acceptable combination.

The generation of a cryptographic key is also dependent on a secret key.

The non-empty subset of parameters comprises the subset of design parameters of the manufacturing device, and the set of parameters relating to the manufacturing method and the subset of characteristic parameters of the at least one manufacturing material.

The method comprises storing watermark data associated with the watermark inserted in said three-dimensional model.

The method comprises storing all of the manufacturing parameters in association with the watermarked model in a file in a predetermined file format, said set of manufacturing parameters being stored in the form of metadata.

According to another aspect, the invention relates to a digital watermark insertion device for the authentication of computer aided manufacturing of a three-dimensional part by a manufacturing device using at least one predetermined manufacturing material, said three-dimensional part to be manufactured being defined by a three-dimensional model obtained by computer-aided design and represented in a predetermined file format, said manufacturing device being designed to be controlled to manufacture said part from said three-dimensional model, said device comprising a module designed to receive a three-dimensional model of a three-dimensional part to be manufactured. This device comprises modules designed to:
determine a non-empty subset of a global set of manufacturing parameters of said part to be manufactured, said non-empty subset of parameters comprising at least one parameter of a subset of design parameters of the manufacturing device, or at least one parameter of a set of parameters relating to the manufacturing method or at least one parameter of a subset of characteristic parameters of the at least one manufacturing material,
generate a cryptographic key as a function of the values of the parameters of said non-empty subset of parameters,
insert as a function of said cryptographic key a watermark formed of a series of N bits, N being a non-zero positive integer, by applying a predetermined watermark insertion algorithm, into said three-dimensional model to obtain a watermarked three-dimensional model of said part to be manufactured.

According to another aspect, the invention relates to an authentication system for the computer-aided manufacturing of a three-dimensional part by a manufacturing device, using at least one predetermined manufacturing material, said three-dimensional part to be manufactured being defined by a three-dimensional model obtained by computer aided design and represented in a predetermined file format, the system comprising a device designed to control said manufacturing device to manufacture said part from said three-dimensional model and from a global set of manufacturing parameters. This system comprises modules designed to:
generate a cryptographic key as a function of the values of the parameters of a non-empty subset of parameters of the global set of manufacturing parameters of said three-dimensional part, said non-empty subset of parameters comprising at least one parameter of a set of design parameters of the manufacturing device, or at least one parameter of a set of parameters relating to the manufacturing method or at least one parameter of a set of characteristic parameters of the at least one manufacturing material,
detect a watermark in said three-dimensional model by applying a predetermined watermark detection algorithm initialized with the generated cryptographic key,
compare the detected watermark with an expected watermark, and authenticate the computer-aided manufacture of said three-dimensional part in the event of a positive comparison.

According to one embodiment, the system comprises a module suitable for inhibiting a manufacturing step of said three-dimensional part in the event of a negative comparison.

### BRIEF DESCRIPTION OF THE DRAWINGS

Other characteristics and advantages of the invention will emerge from the description given below, by way of indication and in no way limiting, with reference to the appended figures, among which:

FIG. 1 schematically illustrates the main steps of a computer-aided manufacturing method of a three-dimensional part according to one embodiment of the invention;

FIG. 2 is a block diagram of the main steps of inserting a watermark according to one embodiment;

FIG. 3 is a block diagram of the main steps in the authentication of computer-aided manufacturing;

FIG. 4 schematically illustrates a three-dimensional part computer-aided manufacturing authentication system according to one embodiment.

### DETAILED DESCRIPTION OF EMBODIMENTS

The invention will be more particularly described in detail in the case of additive manufacturing of three-dimensional parts by 3D printing, using predetermined materials.

However, as already explained, the invention is also applicable for virtual computer aided manufacturing of a digital twin of a real 3D part, for example for prototyping or predictive maintenance purposes.

The invention also applies to the case of computer-aided subtractive manufacturing.

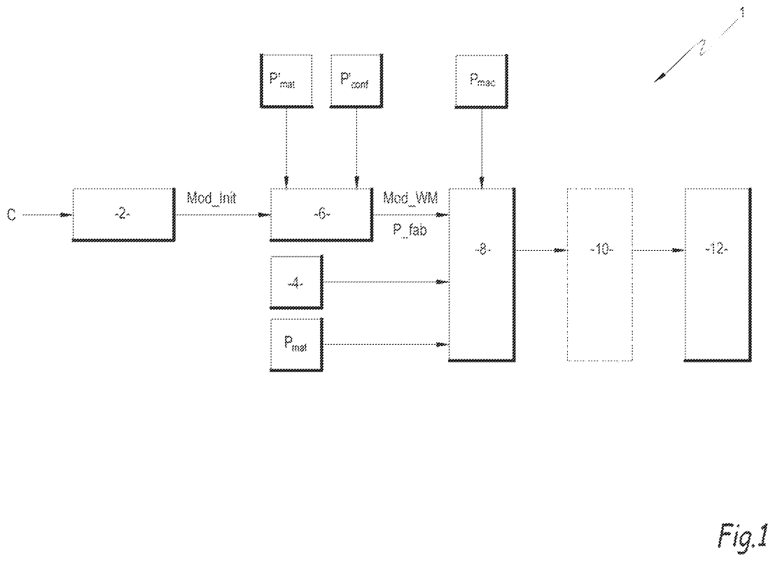

FIG. 1 illustrates the main steps involved in a method 1 of computer-aided production of a three-dimensional part to which the invention applies. In a particular case, this method involves the 3D printing of a part, for example an industrial part or a part intended for the consumer market.

This method comprises a first step 2 of Computer-Aided Design (CAD), conventionally implemented using software dedicated to computer-aided design, making it possible to obtain a model of the part to be manufactured expressed in a predetermined format.

The design is carried out by a first actor, for example a design office or an industrialist.

For example, a so-called 3D CAD type (Computer Aided Design) format is used, this format expressing the three-dimensional geometry of the 3D part to be manufactured. In general, the parts to be manufactured have complex shapes, expressed in geometric shapes such as lines, arcs, B-spline curves. Design step 2 receives as input an initial specification C concerning the part to be manufactured, including physical, thermal and mechanical properties.

For example, these specifications include the desired shape of the part, the mass, the resistance, the temperature range of use.

In addition, we have at the input of step 2 some manufacturing parameters: the manufacturing device, for example the type of 3D printer that will be used for manufacturing, as well as the characteristics of the printing method and the parameters. of the material(s). The values of these parameters are obtained from the initial specifications C or from one or more external databases.

At the end of design step 2, a file in the chosen format is obtained, comprising an initial Mod_init model of the 3D part to be manufactured.

The initial model Mod_init is provided as an input to a step 6 of preprocessing this initial model, which comprises a last watermark insertion operation specific to the invention.

For example, the initial Mod_init model is stored on a non-volatile, computer-readable electronic recording medium, this electronic recording medium being supplied to a device which implements step 6 of preprocessing.

According to one variant, the initial Mod_init model is stored in a file and transmitted via a communications network, according to a chosen communications protocol, to a device which implements step 6 of preprocessing.

The preprocessing step 6 is implemented by a second actor, for example a methods office, which may be different from the first actor, and which, for the insertion of the watermark, uses a trusted third party for computer-aided manufacturing. This trusted third party ensures the sharing of secrets, as described in more detail below, and provides the algorithm for calculating the cryptographic keys K and K′, as described below, from the shared secrets.

Step 6 comprises, prior to the insertion of the watermark, an operation of transforming the initial model Mod_init, into a final model, and a set of metadata.

In addition to the initial Mod_init model, which is a classic CAD model, this operation takes as input a P_{fab} set of parameters of the manufacturing method, and the Pₘₐₜ and P_{conf}′ subsets of the Pₘₐₜ and P_{mac} sets, respectively relative parameters materials and design parameters of the manufacturing device used in the actual manufacturing phase 8 described below.

The values of the parameters of the P_{fab} set of parameters of the manufacturing method, are obtained from experts in the methods office through a human-machine interface, or an external control device, of the device that puts implement step 6 of preprocessing. The values of the parameters of the Pₘₐₜ′ and P_{conf}′ subsets of the Pₘₐₜ and P_{mac} sets are obtained from one or more external databases.

The Pₘₐₜ set of characteristic parameters of the manufacturing material(s) comprises, for example, physical characteristics of the materials, for example polymer or metal, particle size, humidity and oxidation rate, melting point.

For example, the size (particle size) or shape parameters of the material are known during step 6, and therefore belong to the Pₘₐₜ′ subset of Pₘₐₜ. On the other hand, the moisture content of the material, or whether the material (its possible excess) is reusable or not, are examples of Pₘₐₜ parameters that do not belong to the Pₘₐₜ′ subset.

The set of design parameters of the P_{mac} manufacturing device comprises all the parameters to be set for putting the device into operation, i.e. both physical parameters (e.g. physical characteristics of the laser rays), and environmental parameters (atmosphere, humidity).

For example, the temperature parameter of the laser beam should also be known in step 6, and therefore belongs to the P_{conf}′ subset of P_{mac}. On the other hand, parameters relating to the manufacturing environment, such as the level of oxygen or radon in the manufacturing chamber, are examples of P_{mac} parameters that do not belong to the P_{conf}′ subset.

The P_{fab} set of parameters relating to the manufacturing method comprises information relating to the manufacture of the desired part, according to the specifications, for example information relating to the positioning of the part, the support(s) to be used at the time of material deposition or the laser strategy (direction of scanning, etc.) to be implemented for each layer to be manufactured. They also include commands from the manufacturing device for each layer of material to be deposited.

Of course, the P_{fab} parameter set depends on the SLM, DED manufacturing method.

In addition, the sets of parameters Pₘₐₜ, P_{mac} and P_{fab} are partly interdependent, all being related to the part to be manufactured and the means to be used to manufacture it.

The final model is a 3D model, describing the geometry of the part to be manufactured, but in a so-called exchange format, different from that of the initial model, such as for example IGES (Initial Graphics Exchange Specification), STEP (Standard for Exchange of Product Model Data), STL (Stereolitography) or AMF (Additive Manufacturing File Format).

In one embodiment, in this final model, the geometry of the part is very slightly modified depending on some of the parameters taken into account from the global set of manufacturing parameters.

The metadata produced by the transformation operation comprises P_{fab} manufacturing parameters.

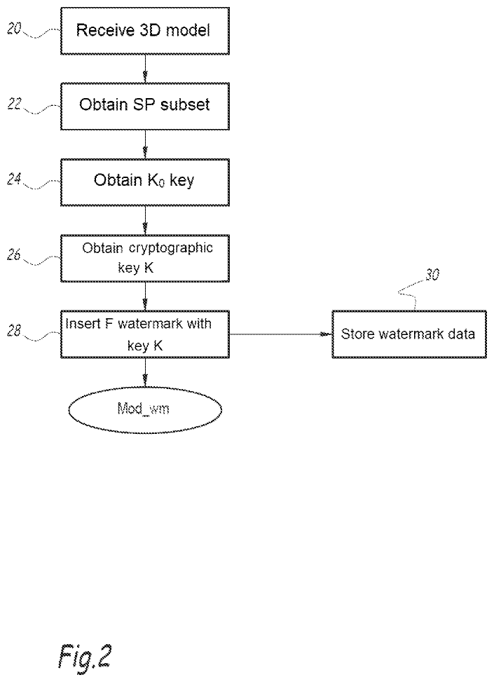

The preprocessing step 6 ends with an operation of inserting a watermark in this model, according to a non-empty subset of the global set of manufacturing parameters, in the 3D model to obtain a watermarked model Mod_WM of the 3D part to be manufactured. A detailed embodiment of the insertion operation will be described in detail below with reference to FIG. 2.

In one embodiment, the watermarked model is stored in a given format file, and the associated P_{fab} manufacturing parameters are also stored in this file in the form of metadata.

Method 1 also comprises a manufacturing step 8 implemented by a computer-aided manufacturing device, for example a 3D printer.

In the case of a manufacturing material of the 3D part, the manufacturer, third actor in the method, receives the material(s) 4 to be used and all the characteristic parameters of the Pₘₐₜ materials, the watermarked model Mod_WM obtained in the preprocessing step 6, as well as the expected values of the parameters relating to the P_{fab} manufacturing method.

The manufacturing device also receives, for example via a man-machine interface that it comprises or from an external control device, a set of complete design parameters P_{mac}, i.e. values for all of the design parameters to operate the manufacturing device.

In the case of the virtual manufacturing of the digital twin of the 3D part, with the sole difference of the above, the manufacturer does not receive the material(s) 4, but only the set of characteristic parameters of the Pₘₐₜ materials and the pre-set parameters of the P_{fab} and P_{mac} sets.

In order to ensure the security of the manufacture and the production of 3D parts having the characteristics provided for in the specifications, the manufacturing step implements an authentication according to the invention implementing a detection of the watermark inserted in the watermarked model. Mod_WM.

In fact, it is a question of securing the manufacturing against cases where the 3D model itself or the manufacturing parameters have been modified, maliciously or not.

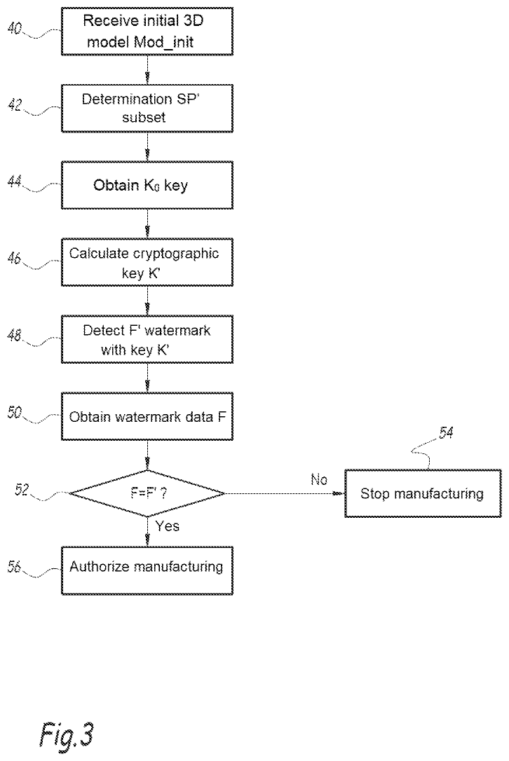

An embodiment of the authentication is detailed below with reference to FIG. 3.

Manufacturing step 8 is carried out by the manufacturer, in cooperation with the trusted third party who contributed to the preprocessing step, more specifically by performing the watermark insertion operation.

In the event of non-authentication of the overall manufacturing method, it is planned to inhibit the printing of the 3D part or its digital twin, i.e. not to trigger it. Advantageously, manufacturing security is then ensured, any use of design parameters that may induce a malfunction of the manufacturing device being prevented. In addition, advantageously, it makes it possible to reduce costs by avoiding the production of potentially defective parts, or to commit resources to the predictive maintenance of such parts or devices illegitimately or improperly used to produce them.

As a variant, the production is not interrupted but the manufactured parts are not approved because they do not correspond to the manufacturing conditions provided to meet the initial specifications.

The production method 1 optionally comprises a postprocessing step 10, comprising for example a finishing operation of the 3D part, for example by milling, sandblasting, polishing, electropolishing, heat treatment, surface treatment, removal of supports, thus than a test operation of the 3D part. This post-postprocessing step is carried out according to methods known in the prior art.

Finally, the method comprises the supply 12 of the parts to a final recipient, who applies for example tests of conformity with the initial specifications.

It should be noted that in the case of virtual manufacturing, the supply 12 of the part is for example the supply of the digital twin of a 3D part to be manufactured to a software application which performs tests and/or predictive maintenance.

It is also envisioned to perform both hardware manufacturing of 3D parts and associated virtual manufacturing, so as to simulate use and perform predictive maintenance on the digital twin of actually used 3D hardware parts.

FIG. 2 is a block diagram of one embodiment of inserting a watermark in preprocessing step 6 described above.

In one embodiment, the watermark insertion is performed by a program code executable instruction module implemented by a programmable electronic device. Preferably, the watermark insertion module is stored and executed in a secure memory and processor, such as existing in a smart card.

In this embodiment described with reference to FIG. 2, the insertion of the watermark comprises a first step 20 of receiving a final 3D model of the part to be manufactured, resulting from all of the preprocessing operations of a original 3D model, except for inserting a watermark.

Step 20 is followed by step 22 of determining at least one non-empty SP subset of the global set of manufacturing parameters.

In this step, which is part of the preprocessing 6, the set of preprocessing parameters consisting of the P_{fab} set of parameters relating to the manufacturing method, and the Pₘₐₜ′ and P_{conf}′ subsets of the Pₘₐₜ and P_{mac}, sets are available, respectively parameters relating to the materials and design parameters of the manufacturing device.

Determination 22 is to determine a non-empty SP subset of the preprocessing parameter set.

In one embodiment, the non-empty SP subset consists of the Pₘₐₜ′ and/or P_{conf}′ and/or P_{fab} parameter set.

Preferably, the non-empty SP subset consists of the set of parameters of the Pₘₐₜ′ and P_{conf}′ and P_{fab} sets.

According to a variant, the non-empty SP subset consists of only one of the Pₘₐₜ′, P_{conf}′ and P_{fab} subsets. For example, the non-empty SP subset is formed by the Ptab subset.

According to another variant, the non-empty SP subset is formed from a predetermined number P of parameters of each of the Pₘₐₜ′, P_{conf}′ and P_{fab} subsets

The method also comprises a step 24 of obtaining a secret key K₀. The secret key K₀. is shared between the methods office and the manufacturer. This sharing is provided by the trusted third party.

According to one variant, the secret key K₀. is associated with an identifier of the initial 3D model Mod_init and shared by all the manufacturers, if there are several, of the part defined by the 3D model Mod_init.

Then, a cryptographic key K calculation is performed in step 26, by applying a cryptographic function parameterized by the secret key K₀. and the non-empty subset SP of parameters chosen in step 22.

For example, a hash function is first applied to the set of concatenated values of the parameters of the chosen subset, to obtain a hash. Any known hash function, such as MD5 (Message Digest 5), SHA-1 or SHA-256 (Secure Hash Algorithm 1 or 256), RIPEMD-160 (RACE Integrity Primitives Evaluation Message Digest 160) or Whirlpool is applicable here. The watermark obtained is then encrypted using a symmetric encryption algorithm and the key K₀, to obtain the cryptographic key K. Any known algorithm, such as AES (Advanced Encryption Standard), MARS, RC6, Serpent, Twofish or Blowfish is applicable here.

As a variant, the cryptographic key K is calculated as the authentication code of a message fingerprint with key, or HMAC (Keyed-Hash Message Authentication Code), i.e. by using a cryptographic hash function in combination with the K₀ key. Any iterative hash function may be used to calculate an HMAC. This is for example the case of MD5 or SHA-1, the resulting algorithm for calculating HMAC being respectively denoted HMAC-MD5 or HMAC-SHA1.

The step 26 of generating a cryptographic key K is followed by a step of inserting a watermark 28 into the final 3D model, the insertion of the watermark being dependent on the cryptographic key K.

For example, in one embodiment, the watermark is formed from a series of N bits {w₁, . . . , w_{N}}, each w₁ being equal to 0 or to 1, N being a predetermined number or depending on the final 3D model. The series of N bits is predetermined or generated randomly. It may also comprise both a predetermined series of bits and a series of bits generated randomly. In a known manner, when it comprises a predetermined series of bits, it may for example include an identifier of a methods office, of a manufacturer, or of a manufacturing device.

For example, the watermark insertion method used is the method described in the article “Digital Watermark of 3D CAD Product Model” by X. Feng et al, published in International Journal of Security and Its Applications”, vol. 9, No. 9, 2015. This method consists in modifying certain coordinates of geometric entities defining the 3D model, while preserving the final geometry of the part.

According to one embodiment, the points whose coordinates are modified are selected randomly, the random path function being initialized by the cryptographic key K.

According to one variant, in the series of N bits {w₁, . . . , w_{N}} forming the inserted watermark, it is the points whose coordinates are modified which are selected randomly. In other words, in this embodiment, the generated watermark is a random generated using the cryptographic key K.

Of course, this is an exemplary embodiment of the watermark insertion. There are many known so-called blind methods, i.e. in which the watermark is detectable from the watermarked model, without the need to use the initial 3D model. Any known method of inserting a watermark into a 3D model of this type may be used. Advantageously, the calculated cryptographic key K may be used as a cryptographic hazard in the insertion of the watermark.

Thus, a watermarked model Mod_WM is obtained. Note that when using the watermark insertion method described above, the metadata of the file in which the 3D model is stored is not changed by the watermark insertion.

The method also comprises a step 30 of storing the watermark data F, for example of the series of N bits {w₁, . . . , w_{N}} forming the watermark in the case where the watermark is predetermined.

According to one embodiment, the watermark data F is stored by the trusted third party, for example in a file. Alternatively, the watermark data is also inserted into the metadata of the file in which the 3D model is stored.

In the case where the watermark is the random generated using the cryptographic key K, the storing step 30 is omitted.

FIG. 3 is a block diagram of the main steps of a manufacturing method authentication method, implemented by a control computer of a manufacturing device, typically 3D printing.

The authentication method comprises, in this manufacturing phase, a first step 40 for receiving a 3D model comprising code instructions for the manufacture of a 3D part by a manufacturing device.

For example, this 3D model is received as an interchange format file as described above, including metadata.

A legitimate file is a file having a watermark inserted by a method as described above with reference to FIG. 2.

The method also comprises a step 42 of receiving a global set of parameters and determining a non-empty SP′ subset of parameters.

The global set of parameters comprises the P_{fab} set of parameters relating to the manufacturing method, obtained for example by extracting these parameters from the metadata of the file received, the Pₘₐₜ set of characteristic parameters of the material(s), provided by the supplier of raw materials, and the P_{mac} set of design parameters of the manufacturing device itself, received from a man-machine interface of this device, or from an external control device.

The set of Pₘₐₜ parameters characteristic of the material(s) is a superset of the Pₘₐₜ′ parameters used in the pretreatment step.

The manufacturing device design P_{conf}′ parameter set is a superset of the P_{conf}′ parameters used in the preprocessing step.

The determination 42 of the non-empty subset SP′ comprises determining the parameters homologous to those determined in step 22 carried out during the watermark insertion, from the parameter sets P_{fab}, Pₘₐₜ and P_{mac}.

Thus, if the non-empty subset SP of parameters from step 22 were composed of a concatenation of the parameters Pₘₐₜ′ et P_{conf}′ and P_{fab}, the subset of parameters SP′ is formed from the parameters, corresponding to the parameters. Pₘₐₜ′ and P_{conf}′ and P_{fab}, parameters, extracts from Pₘₐₜ, P_{mac} and P_{fab}.

Without modification of the watermarked model Mod_WM, and if the values of the non-empty SP′ subset of the homologous received parameters of the non-empty SP subset of parameters chosen for the watermark insertion are equal to those used for the watermark insertion, the watermark data used for its insertion are equal to those of the watermark extracted from the watermarked model during the manufacturing phase.

The authentication method comprises obtaining 44 the key K₀ used for the insertion of the watermark. In fact, in this case, the secret key K₀ is a shared secret to improve the degree of confidence of the authentication.

The secret key is obtained from the trusted third party.

For example, it is stored, for example on a secure device such as a secure smart card, provided by the trusted third party.

Then in step 46 a cryptographic key K′ is calculated by applying the same algorithm as that used in step 26, i.e. the same cryptographic function parameterized by the secret key K₀, to the concatenated values of the sub set SP′ of the set of parameters received homologous to the non-empty subset SP of the global set of parameters chosen for the insertion of the watermark.

A watermark F′ is detected or extracted in the watermark detecting step 48 from the received watermark template using the cryptographic key K′, applying a detection method associated with the watermark insertion method applied to the watermark. watermark insertion step 28. The cryptographic key K′ is used analogously to the use of the cryptographic key K during the insertion.

For example, the cryptographic key K′ is used to determine the points whose coordinates are supposed to be changed by the insertion of a watermark.

Alternatively, the cryptographic key K′ is used to generate the expected watermark data.

At the end of the detection step 48, a series of N binary values (0 or 1) is extracted from the watermarked model.

The expected F watermark data is obtained in step 50. The expected watermark data is the watermark data inserted into the genuine file in the step 6 of preprocessing the initial template, which was stored in the step 30 of inserting a watermark.

For example, they are obtained on request from the methods office based on a unique identifier of the watermarked model received, or are provided with it by the methods office.

In one embodiment, the watermark data F are therefore obtained in step 50 by requesting a memory where they have been stored by the methods office, or on a removable medium where they have been provided jointly by it with the watermarked model.

This F watermark data is compared in the comparing step 52 with the F watermark data extracted from the received file.

In the event of a negative comparison in step 52, it is deduced that the overall manufacturing method is not authenticated. For safety reasons, it is then possible to inhibit, i.e. not to trigger, the step of manufacturing the 3D part in step 54.

In the event of a positive comparison, the authenticity of the manufacturing method is attested and therefore the manufacture of the part is authorized (step 56).

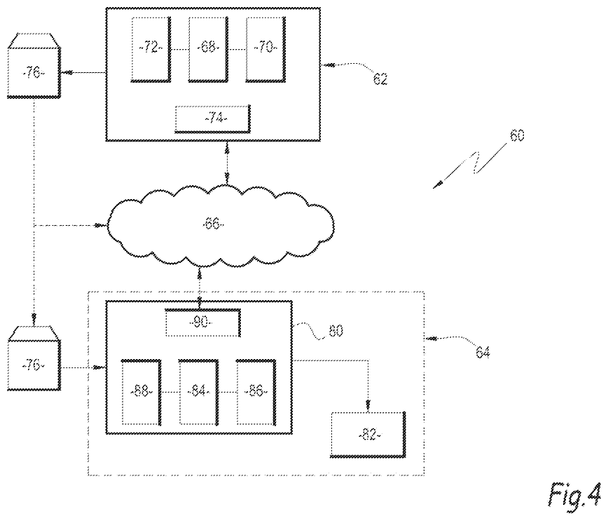

FIG. 4 schematically illustrates a 3D parts manufacturing authentication system according to one embodiment.

System 60 comprises a watermark inserter 62 and a 3D part manufacturing subsystem 64, both connected to a communications network 66.

The insertion device 62 is a programmable electronic device, for example a computer, or an electronic device produced in the form of programmable logic components, such as an FPGA (Field-Programmable Gate Array), or else in the form of dedicated integrated circuits, of the ASIC (Application-Specific Integrated Circuit) type. The device 62 is typically integrated into a device for preparing the production of the methods office, not shown.

It comprises in particular a central computing unit 68, or CPU, comprising one or more electronic processors, able to execute computer program instructions when the device 62 is powered on.

The device 62 also comprises an electronic memory unit 70 designed to store information, in particular registers. In particular, executable code instructions capable of implementing the methods according to the invention are stored.

The device 62 comprises a control interface 72 making it possible to update parameters and receive commands from an operator, as well as a communication module 74 making it possible to receive and communicate data via the network 66 according to protocols of communication given. The various functional blocks of device 62 described above are connected via a communication bus.

The device 62 is designed to implement the insertion of a watermark in a file representing an initial model of a 3D part to be manufactured, making it possible to obtain a file with a watermark 76.

File 76 is transmitted over communications network 66 or through an electronic non-volatile data storage medium to a watermark authentication device 80 forming part of a manufacturing subsystem 64.

The device 80 is also suitable for controlling a device 82 for manufacturing 3D parts, for example a 3D printer.

The device 80 is a programmable electronic device, for example a computer, or an electronic device produced in the form of programmable logic components, such as an FPGA (Field-Programmable Gate Array), or else in the form of integrated circuits. dedicated, ASIC (Application-Specific Integrated Circuit) type.

It comprises in particular a central computing unit 84, or CPU, comprising one or more electronic processors, able to execute computer program instructions when the device 80 is powered on.

The device 80 also comprises an electronic memory unit 86 suitable for storing information, in particular registers. In particular, executable code instructions capable of implementing the authentication method according to the invention are stored.

The device 80 comprises a control interface 88 making it possible to update parameters and receive commands from an operator, as well as a communication module 90 making it possible to receive and communicate data via the network 66 according to a protocol. given communication. The various functional blocks of device 80 described above are connected via a communication bus.

1. Method for authenticating the computer-aided manufacturing of a three-dimensional part by a manufacturing device, using at least one predetermined manufacturing material, the three-dimensional part to be manufactured being defined by a three-dimensional model obtained by computer-aided design and represented in a predetermined file format, the manufacturing device being designed to be controlled to manufacture the part from the three-dimensional model and from a global set of manufacturing parameters, the method comprising:
generating a cryptographic key as a function of the values of the parameters of a non-empty subset of parameters of the global set of manufacturing parameters of the three-dimensional part the non-empty subset of parameters comprising at least one parameter of a set of design parameters of the manufacturing device, or at least one parameter of a set of parameters relating to the manufacturing method, or at least one parameter of a set of characteristic parameters of the at least one manufacturing material;
detecting a watermark in the three-dimensional model by applying a predetermined watermark detection algorithm initialized with the generated cryptographic key;
comparing the detected watermark with an expected watermark; and
authenticating the computer-aided manufacture of the three-dimensional part when said comparing is affirmative.

2. Method according to claim 1, further comprising inhibiting a manufacturing step of the three-dimensional part when said comparing is non-affirmative.

3. Method according to claim 1, wherein the non-empty subset of parameters is determined prior to said generating, and comprises the set of parameters relating to the manufacturing method, and a predetermined subset of design parameters of the manufacturing, and a predetermined subset of characteristic parameters of the at least one manufacturing material.

4. Method according to claim 1, wherein the cryptographic key is also a function of a secret key.

5. Method according to claim 1, further comprising extracting the set of parameters relating to the method of manufacturing metadata associated with the three-dimensional model received.

6. Method according to claim 1, further comprising receiving the set of design parameters of the manufacturing device, from a man-machine interface of the manufacturing device, or from an external control device.

7. Method according to claim 1, wherein the detected watermark is formed of a series of N bits, N being a non-zero positive integer, the method further comprising obtaining of the expected watermark from a memory.

8. Digital watermark insertion method for the authentication of computer-aided manufacturing of a three-dimensional part by a manufacturing device using at least one predetermined manufacturing material, the three-dimensional part to be manufactured being defined by a three-dimensional model obtained by computer-aided design and represented in a predetermined file format, the manufacturing device being designed to be controlled to manufacture the part from the three-dimensional model, the method comprising obtaining a three-dimensional model of a three-dimensional part to be manufactured, comprising:
determining a non empty subset of a global set of manufacturing parameters of the part to be manufactured, the non-empty subset of parameters comprising at least one parameter of a subset of design parameters of the manufacturing device, or at least one parameter of a set of relative parameters the manufacturing method, or at least one parameter of a subset of characteristic parameters of the at least one manufacturing material;
generating a cryptographic key as a function of the values of the parameters of the non-empty subset of parameters; and
inserting as a function of said cryptographic key of a watermark formed of a series of N bits, N being a non-zero positive integer, by applying a predetermined watermark insertion algorithm, into the three-dimensional model for obtaining a watermarked three-dimensional model of the part to be manufactured.

9. Method according to claim 8, wherein cryptographic key is also a function of a secret key.

10. Method according to claim 8, wherein the non-empty subset comprises the subset of design parameters of the manufacturing device, the set of parameters relating to the manufacturing method, and the subset of characteristic parameters of at least one manufacturing material.

11. Method according to claim 8, comprising providing a storage of watermark data associated with the watermark inserted in the three-dimensional model.

12. Method according to claim 8, comprising providing a storage of the set of manufacturing parameters in association with the three-dimensional watermarked model in a file in predetermined file format, the set of manufacturing parameters being stored in the form of metadata.

13. Digital watermark insertion device for the authentication of computer-aided manufacturing of a three-dimensional part by a manufacturing device using at least one predetermined manufacturing material, the three-dimensional part to be manufactured being defined by a three-dimensional model obtained by computer-aided design and represented in a predetermined file format, the manufacturing device being designed to be controlled to manufacture the part from the three-dimensional model, the device comprising a module designed to receive a three-dimensional model of a three-dimensional part to be manufactured, comprising:
a module to determine a non-empty subset of a global set of manufacturing parameters of the part to be manufactured, the non-empty subset of parameters comprising at least one parameter of a subset of design parameters of the manufacturing device, or at least one parameter of a set of relative parameters the manufacturing method, or at least one parameter of a subset of characteristic parameters of the at least one manufacturing material;
a module to generate a cryptographic key as a function of the values of the parameters of the non-empty subset of parameters; and
a module to insert as a function of the cryptographic key a watermark formed of a series of N bits, N being a non-zero positive integer, by applying a predetermined watermark insertion algorithm, into the three-dimensional model to obtain a watermarked three-dimensional model of the part to be manufactured.

14. Authentication system of computer-aided manufacturing of a three-dimensional part by a manufacturing device, using at least one predetermined manufacturing material, the three-dimensional part to be manufactured being defined by a three-dimensional model obtained by computer-aided design and represented in a predetermined file format, the system comprising a device designed to control the manufacturing device to manufacture the part from the three-dimensional model and from a global set of manufacturing parameters, the system comprising:
a module to generate a cryptographic key as a function of the values of the parameters of a non-empty subset of parameters of the global set of manufacturing parameters of the three-dimensional part, the non-empty subset of parameters comprising at least one parameter of a set of design parameters of the manufacturing device, or at least one parameter of a set of parameters relating to the manufacturing method. or at least one parameter a set of characteristic parameters of at least one manufacturing material;
a module to detect a watermark in the three-dimensional model by applying a predetermined watermark detection algorithm initialized with the cryptographic key generated; and
a module to compare the detected watermark with an expected watermark, and authenticate the computer-aided manufacture of the three-dimensional part in the event of a positive comparison.

15. System according to claim 14, comprising a module designed to inhibit a manufacturing step of the three-dimensional part in the event of a negative comparison.
